(19) United States
(12) Patent Application Publication
(10) Pub. No.: US 2016/0348305 A1
(43) Pub. Date: Dec. 1, 2016

(54) RAW MATERIAL AND USE THEREOF TO REDUCE CREASES IN TEXTILES

(71) Applicant: Henkel AG & Co. KGaA, Duesseldorf (DE)

(72) Inventors: Benoit Luneau, Ratingen (DE); Carolin Kruppa, Hilden (DE); Janice Mahnke, Wuppertal (DE); Mareile Job, Leverkusen (DE); Peter Schmiedel, Duesseldorf (DE); Bent Rogge, Duesseldorf (DE); Christina Roeleke, Moenchengladbach (DE); Karin Kania, Moenchengladbach (DE)

(73) Assignee: Henkel AG & Co. KGaA, Duesseldorf (DE)

(21) Appl. No.: 15/235,224

(22) Filed: Aug. 12, 2016

Related U.S. Application Data
(63) Continuation of application No. PCT/EP2014/075243, filed on Nov. 21, 2014.

(30) Foreign Application Priority Data
Mar. 4, 2014 (DE) 10 2014 203 865.0

(51) Int. Cl. D06M 13/513; C07F 7/18

(52) U.S. Cl. CPC D06M 13/513; C07F 7/1836; D06M 2200/20

(57) ABSTRACT

Raw materials that constitute reaction products of two compounds (1) and (2) having the general formulas (1) and (2), wherein the first compound (1) having the general formula (1): R¹—(CH₂)^{a}—(CHR²)_{b}—(CR³₂)_{c}—(CHR⁴)_{d}—(CH₂)ₑ—R⁵, and the second compound (2) has the general formula (2): Y-A-Si(OR1)r(R2)₃₋ᵣ, exhibit anti-wrinkle properties. They are used in laundry detergents, fabric softeners or textile treatment compositions that are applied to the textile outside a washing machine or a dryer.

### FIELD OF THE INVENTION

The present invention generally relates to a raw material having anti-wrinkle properties, to the production thereof, and to the use of the raw material for reducing creases or creasing in textiles, to a textile treatment composition containing the raw material, to a kit containing the textile treatment composition, and to a method for using the textile treatment composition.

### BACKGROUND OF THE INVENTION

International patent application WO 2001/060961 discloses aqueous compositions for reducing wrinkles in textiles, describing a polyalkyleneoxide polysiloxane having the formula

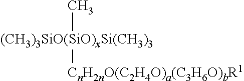

where x is a number from 1 to 8, n is a number from 3 to 4, a is a number from 1 to 15, and b is a number from 0 to 14, where furthermore a+b is 5 to 15, and R¹ is selected from the group consisting of hydrogen, an alkyl group having 1 to 4 carbon atoms, and an acetyl group, wherein the polyalkyleneoxide polysiloxane has a molecular weight of less than 1000. Preferred polyalkyleneoxide polysiloxanes are those commercially available as Silwet® L 7280 or Silwet® L 7608 or Silwet® L 77.

International patent application WO 2001/061100 describes aqueous compositions for controlling wrinkles in fabrics, which, in addition to water, include an effective amount of a polymer comprising carboxylic acid moieties and are sprayed onto the fabrics. The pH value of the aqueous compositions is between 3 and 6.5. It is also possible to use silicone compounds and/or silicone emulsions as a further active ingredient, such as those commercially available as Silwet® L 7001 or Silwet® L 77.

International patent application WO 2003/083204 discloses an ironing aid, which contains a thermoplastic elastomer for reducing the elasticity and for resistance against creasing/wrinkling of the fabric, wherein the thermoplastic elastomer preferably is a core polymer including carbon-carbon bonds and/or silicon-oxygen bonds in the backbone and comprises at least two or more flanking polymers.

International patent application WO 2009/024449 relates to coatings of surfaces such as shoes or glass based on silyl-functional prepolymers based on polyalkylene oxide, which carry hydrolyzable silyl terminal groups at the free ends thereof. These are silyl-terminated linear prepolymers that can cross-link with each other and with the surface of the surface to be coated, wherein the silyl-terminated linear prepolymers are obtainable by reacting compounds having the general formula (I)

X-A-X′ (I),
where
A is a polyoxyalkylene chain of ethylene oxide units or ethylene oxide and propylene oxide units containing a maximum fraction of 50 wt. % of propylene oxide units, based on the weight of A;
X is OH, NH₂, NHR, NR₂ or OR, wherein the R groups independently of one another are a linear or branched alkyl group having 1 to 10 carbon atoms, an alkaryl or aralkyl group having 6 to 10 carbon atoms, or an aryl group having 5 to 10 carbon atoms;
X is OH, NH₂, NHR or NR₂, wherein the R groups independently of one another are a linear or branched alkyl group having 1 to 10 carbon atoms, an alkaryl or aralkyl group having 6 to 10 carbon atoms, or an aryl group having 5 to 10 carbon atoms; and the compound having the general formula (I) has a number average molecular weight of at least 100 g/mol,
with compounds having the general formula (II)

Y—B—Si(OR1)ᵣ(R2)₃₋ᵣ (II)
where
Y is a group that is reactive towards OH, NH2, NHR and/or NR2:
B is a chemical bond or a divalent, low molecular weight organic group having preferably 1 to 50 carbon atoms;
OR1 is a hydrolyzable group;
R2 is a linear or branched alkyl group having 1 to 6 carbon atoms; and
r is a number from 1 to 3; and
unreacted hydrogen atoms of group X and/or group X′ are optionally alkylated.

Furthermore, WO 2009/024449 describes the use of the aforementioned silyl-terminated linear prepolymers, or the use of corresponding mixtures, as additives in laundry detergents, cleaning agents and fabric treatment agents for hard and soft surfaces to prevent or reduce soiling or redeposition. A further use of the silyl-terminated linear prepolymers, or of the corresponding mixtures, involves fixing or retaining colorants on the fiber by the hydrogel coating on fabrics, either due to the structure of the hydrogel itself or else by additional functionalities, which are preferably contributed by the above-mentioned entities. A functionality with respect to the reduction of creases or an anti-wrinkle action is not described.

It was the object of the invention to provide a raw material that is suitable for reducing creases in textiles, wherein the raw material constitutes neither a polysiloxanes nor another polymer.

Furthermore, other desirable features and characteristics of the present invention will become apparent from the subsequent detailed description of the invention and the appended claims, taken in conjunction with this background of the invention.

### BRIEF SUMMARY OF THE INVENTION

A raw material that constitutes the reaction product of two compounds (1) and (2) having the general formulas (1) and (2), wherein the first compound (1) has the general formula

—R¹—(CH₂)ₐ—(CHR²)_{b}—(CR³₂)_{c}—(CHR⁴)_{d}—(CH₂)ₑ—R⁵ (1)
where R¹, R², R³, R⁴ and R⁵, independently of one another, are each an OH, NH₂, NHR′ and/or SH reactive group, and R′ is a linear or branched alkyl chain having 1 to 10 carbon atoms, an alkaryl or aralkyl group having 6 to 10 carbon atoms, or an aryl group having 5 to 10 carbon atoms, and a, b, c, d, and e can each be 0 or an integer between 1 and 10, with the condition that the sum of a+b+c+d+e is an integer greater than 1; and the second compound (2) has the general formula

Y-A-Si(OR1)ᵣ(R2)₃₋ᵣ (2)
where Y is NCO, Br or Cl, COOH, COCl, an epoxy, aldehyde or acrylate group; A is a linear or branched alkyl chain having 1 to 20 carbon atoms, an alkaryl or aralkyl group having 6 to 20 carbon atoms, or an aryl group having 5 to 20 carbon atoms; OR1 is a hydrolyzable group; R2 is a linear or branched alkyl group having 1 to 6 carbon atoms; and r is a number from 1 to 3,

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

One subject matter of the invention is a raw material that constitutes the reaction product of the two compounds (1) and (2) having the general formulas (1) and (2), wherein the first compound (1) has the general formula

R¹—(CH₂)ₐ—(CHR²)_{b}—(CR³₂)_{c}—(CHR⁴)_{d}—(CH₂)ₑ—R⁵ (1)
where
R¹, R², R³, R⁴ and R⁵, independently of one another, are each an OH, NH₂, NHR′ and/or SH reactive group, and R′ is a linear or branched alkyl chain having 1 to 10 carbon atoms, an alkaryl or aralkyl group having 6 to 10 carbon atoms, or an aryl group having 5 to 10 carbon atoms, and a, b, c, d, and e can each be 0 or an integer between 1 and 20, with the condition that the sum of a+b+c+d+e is an integer greater than 1;
and the second compound (2) has the general formula

Y-A-Si(OR1)ᵣ(R2)₃₋ᵣ (2)
where
Y is NCO, Br or Cl, COOH, COCl, an epoxy, aldehyde or acrylate group;
A is a linear or branched alkyl chain having 1 to 20 carbon atoms, an alkaryl or aralkyl group having 6 to 20 carbon atoms, or an aryl group having 5 to 20 carbon atoms;
OR1 is a hydrolyzable group;
R2 is a linear or branched alkyl group having 1 to 6 carbon atoms; and
r is a number from 1 to 3.

So as to obtain a reaction product of compound (1) and compound (2), at least one functional group of compound (1) must be reacted. Preferred, however, are raw materials in which at least 2 functional groups of compound (1), and in particular at least 3 functional groups, are reacted with compound (2). Especially particularly preferred are raw materials in which all functional groups of compound (1) are reacted with compound (2). The molar ratio of compound (2) to compound (1) in the raw material according to the invention is 1:1 to (2+b+2c+d):1.

The groups R¹ to R⁵ are preferably OH, NH₂ or NHR′, independently of one another. The group R′ preferably denotes a linear or branched alkyl chain having 1 to 10 carbon atoms, and preferably 1 to 6 carbon atoms.

If the groups R¹ to R⁵ in the general formula (1) are OH, NH₂ or NHR′, the reaction with the compound having the general formula (2) usually takes place with separation of the compound HY, or else with addition, such as in the case of a reaction of an OH group with an isocyanatoalkyl alkoxysilane (formation of urethane).

Particularly preferred representatives of compound class (1) are compounds including only OH as the groups R¹ to R⁵ in formula (1).

Representatives of the compound having the general formula (1) have a sum of a+b+c+d+e that is greater than 1, but no more than 100. Preferred representatives of the compounds (1) present in preferred raw materials are those in which the sum of a+b+c+d+e is greater than 1, but no more than 20, and in particular no more than 10.

Still more preferred are raw materials containing representatives of compound class (1) that meet both conditions (R¹ to R⁵ are only OH, and the sum of a+b+c+d+e+is no more than 20, and in particular no more than 10). Compound (1) is most preferably xylitol, glycerol and polyethylene glycols, and end group-capped polyethylene glycols, especially non-end group-capped polyethylene glycols having a molecular weight of less than 4000 g/mol, in particular less than 2000 g/mol, less than 1000 g/mol being preferred, for example 200 g/mol or 400 g/mol.

In a preferred embodiment of the raw materials, Y in compounds having the general formula (2) is Cl, NCO, COOH, a carboxylic acid chloride group, an acrylate group, or an epoxy group, and A is a linear or branched alkyl chain having 1 to 20 carbon atoms, and in particular up to 6 carbon atoms.

The preferred compounds having the general formula (2) include all functional silane derivatives that are capable of reacting with respect to OH groups and NH₂ groups. Examples include (meth)acrylate silanes such as (3-(meth)acryloxypropyl)trimethoxysilane, ((meth)acryloxymethyl)triethoxysilane and ((meth)acryloxymethyl)methyl-dimethoxysilane, but in particular also isocyanato silanes such as (3-isocyanatopropyl)trimethoxysilane, (3-isocyanatopropyl)triethoxysilane, (isocyanatomethyl)methyl dimethoxysilane and (isocyanato-methyl)trimethoxysilane, or aldehyde silanes such as triethoxysilyl undecanal and triethoxysilyl butyraldehyde, epoxy silanes such as (3-glycidoxypropyl)trimethoxysilane, anhydride silanes such as 3-(triethoxysilyl)propylsuccinic acid anhydride, halogen silanes such as chloromethyltrimethoxysilane, 3-chloropropylmethyldimethoxysilane, and tetraethyl orthosilicate (TEOS), which are commercially available from Wacker Chemie GmbH (Burghausen), Gelest, Inc, (Morrisville, USA) or ABCR GmbH & Co, KG (Karlsruhe), for example, or can be produced using known methods. Isocyanato silanes and anhydride silanes are particularly preferred. When all hydroxy ends are fully reacted with isocyanato silanes, fully silylated raw materials are obtained. In such a case, group A only includes the atom group that in the starting isocyanato silane is located between the isocyanato group and the silyl group. When all hydroxy ends are fully reacted with anhydride silanes, for example 3-(triethoxysilyl)propylsuccinic acid anhydride, the result is likewise fully silylated raw materials. In such a case, group A only includes the atom group that in the starting anhydride silane is located between the anhydride group and the silyl group.

An especially particularly preferred representative of the compounds having the general formula (2) is a (3-isocyanatopropyl)trialkoxysilane, and preferably (3-isocyanatopropyl)triethoxysilane (IPTES).

In a further preferred embodiment of the invention, raw materials are provided in which at least 2 functional groups of the first compound having the general formula (1), and preferably all functional groups of the first compound having the general formula (1), are reacted with at least two different compounds having the general formula (2), for example 2 to 5 different compounds having the general formula (2).

In general, however, it is preferred for the functional groups of the first compound (1) to not be reacted with different second compound (2).

The raw materials can be produced using arbitrary methods known from the prior art. In general, a solution is prepared from the first compound having the general formula (1) in an organic solvent, optionally at an elevated temperature. Organic solvents that can be used include dioxane, tetrahydrofurane and similar solvents known to a person skilled in the art, for example, which after the reaction are easy to remove again from the reaction mixture. The compound (2) is usually added after cooling at room temperature, at a molar ratio of compound (2) to compound (1) of 1:1 to (2+b+2c+d):1. Optionally, a starter or catalyst may also be added in this stage. In particular in the case of isocyanate compounds (2), it is recommended to add a catalyst such as 1,4-diazabicyclo[2.2.2]octane (DABCO). The reaction mixture is preferably heated, for example to temperatures of 40° C. to 120° C., and stirred over an extended period, which for efficiency reasons should not exceed one day. Afterwards, the organic solvent is separated using methods known to the person skilled in the art. With such a production of the raw materials, it is also possible for mixtures of reaction products with a varying number of reacted functional groups of compound (1) to be present. Within the scope of the present invention, such mixtures of obtained components with an optionally varying number of reacted groups, which, however, are obtained from a defined amount of a certain compound (1) and a defined amount of a certain compound (2), shall be understood to mean a reaction product, and thus also a raw material.

When used on textiles, the raw materials exhibit anti-wrinkle properties.

A further subject matter of the invention is thus the use of a raw material that constitutes the reaction product of compounds (1) and (2) for reducing creases and creasing in textiles.

A further preferred subject matter of the invention is a textile treatment composition comprising at least one raw material that constitutes a reaction product of compounds (1) and (2) in amounts of 1 to 50 wt. %. The compositions can also include two or three or more raw materials made of different compounds (1) and/or compounds (2), wherein the sum of these raw materials is 1 to 50 wt. %. In particular, however, it is preferred that only one raw material according to the invention is present in the textile treatment composition, or that two raw materials according to the invention are present in the textile treatment composition.

In addition to the raw materials according to the invention, the textile treatment compositions can also include further components known from the prior art as components that exhibit anti-wrinkle properties or fiber lubricant properties or shape retention properties. These include above all the silicones and polysiloxanes, amines and amino silicones, alcohols, polyols and polysaccharides, cyclodextrins, acrylates, polyurethanes, oils and clays, but also further polymers, urea, polyisocyanates, amides and lipids known for this purpose. Non-limiting examples of shape retention polymers include starches and starch derivatives, chitins and chitin derivatives, but also synthetic polymers, which are commercially available for this purpose. Sokalan EG 310®, available from BASF, or Moweol®, available from Clariant, or polyamine resins such as Cypro 515®, available from Cytec Industries, shall be mentioned here only by way of example.

The sum of all components having anti-wrinkle properties, fiber lubricant properties and shape retention properties can thus also exceed 50 wt. % in the textile treatment compositions. In a further preferred embodiment of the invention, the textile treatment composition is a laundry detergent or a fabric softener. Among these, in turn, liquid to gel-like embodiments are preferred. Advantageously, such laundry detergents or fabric softeners, and in particular liquid to gel-like laundry detergents or liquid to gel-like fabric softeners, have a content of at least one raw material made of compounds (1) and (2) of 1 to 20 wt. %, and in particular of 2 to 10 wt. %.

Preferred laundry detergents, and in particular liquid to gel-like laundry detergents, moreover include at least one, and preferably two or more components selected from the following groups: surfactants, in particular anionic and/or non-ionic and/or cationic surfactants, builders, organic solvents, bleaching agents, electrolytes, enzymes, pH-adjusting agents, perfumes, perfume carriers, fluorescent agents, dyes, hydrotopics, foam inhibitors, silicone oils, anti-redeposition agents, graying inhibitors, shrinkage preventers, dye transfer inhibitors, antimicrobial active agents, germicides, fungicides, antioxidants, preservatives, corrosion inhibitors, antistatic agents, bittering agents, repellents and impregnating agents, swelling and anti-slip agents, softening components and UV absorbers.

Suitable anionic surfactants comprise alkylbenzene sulfonic acid salts, olefin sulfonic acid salts, C₁₂₋₁₈ alkane sulfonic acid salts, fatty alcohol sulfates/alkyl sulfates, fatty alcohol ether sulfates/alkyl ether sulfates, but also fatty acid soaps or a mixture of two or more of these anionic surfactants. Among these anionic surfactants, alkylbenzene sulfonic acid salts, fatty alcohol (ether) sulfates, and mixtures thereof are particularly preferred.

Further suitable anionic surfactants are fatty acid soaps. Saturated and unsaturated fatty acid soaps are suitable, such as the salts of lauric acid, myristic acid, palmitic acid, stearic acid, (hydrogenated) erucic acid and behenic acid, and in particular soap mixtures derived from natural fatty acids, such as coconut oil, palm kernel oil, olive oil, or tallow fatty acids. The laundry detergents preferably have a content of fatty acid soaps of 0 to 5 wt. %.

The anionic surfactants, including the fatty acid soaps, can be present in the form of the sodium, potassium, magnesium or ammonium salts thereof. The anionic surfactants are preferably present in the form of the sodium salts and/or ammonium salts thereof. Amines that may be used for neutralization include preferably choline, triethylamine, monoethanolamine, diethanolamine, triethanolamine, methylethylamine, or a mixture thereof, wherein monoethanolamine is preferred.

Suitable non-ionic surfactants include alkoxylated fatty alcohols, alkoxylated (oxo) alcohols, alkoxylated fatty acid alkyl esters, fatty acid amides, alkoxylated fatty acid amides, polyhydroxy fatty acid amides, alkylphenol polyglycol ethers, amine oxides, alkylpolyglucosides and mixtures thereof.

Preferred alkoxylated fatty alcohols are ethoxylated, in particular primary alcohols having preferably 8 to 18 carbon atoms, and on average 2 to 12 moles ethylene oxide (EO) per mole of alcohol, in which the alcohol residue is linear. In particular, alcohol ethoxylates having 12 to 18 carbon atoms, for example of coconut, palm, tallow fatty or oleyl alcohol, and an average of 5 to 8 EO per mole of alcohol are particularly preferred. The preferred ethoxylated alcohols include, for example. C₁₂₋₁₄ alcohols having 2 EO, 3 EO, 4 EO or 7 EO, C₉₋₁₁ alcohol having 7 EO, C₁₂₋₁₈ alcohols having 3 EO, 5 EO, or 7 EO, C₁₆₋₁₈ alcohols having 5 EO or 7 EO, and mixtures thereof. In addition to these non-ionic surfactants, alcohols having more than 12 EO may also be used. Examples of these are tallow fatty alcohol having 14 EO, 25 EO, 30 EO, or 40 EO. It is particularly preferred to use a C₁₂₋₁₈ alcohol, and in particular a C₁₂₋₁₄ alcohol, or a C₁₃ alcohol having an average of 2 EO or 3 EO as the non-ionic surfactant.

In addition to the pure ethylene oxide adducts, however, corresponding propylene oxide adducts, and in particular also EO/PO mixed adducts, are advantageous, with C₁₆-C₁₈ alkyl polyglycol ethers having 2 to 8 EO and PO each being particularly preferred. In some embodiments, EO/BO mixed adducts, and even EO/PO/BO mixed adducts are preferred. The particularly preferred EO/PO mixed adducts include C₁₆-C₁₈ fatty alcohols having fewer PO units than EO units, and in particular C₁₆-C₁₈ fatty alcohols having 4 PO and 6 EO, or C₁₆-C₁₈ fatty alcohols having 2 PO and 4 EO.

The degrees of alkoxylation indicated (EO=ethylene oxide; PO=propylene oxide; BO=butylene oxide) represent statistical averages that can correspond to an integer or a fractional number for a specific product. Preferred alkoxylates exhibit a restricted distribution of homologs.

In particular silicates, aluminum silicates (in particular zeolites), carbonates, salts of organic di- and polycarboxylic acids, and mixtures of these substances, shall be mentioned as builders.

Organic builders are, for example, the polycarboxylic acids that can be used in the form of the sodium salts thereof, wherein polycarboxylic acids shall be understood to mean those carboxylic acids that carry more than one acid function. These include, for example, citric acid, adipic acid, succinic acid, glutaric acid, malic acid, tartaric acid, maleic acid, fumaric acid, saccharic acids, aminocarboxylic acids, and mixtures thereof. Preferred salts are the salts of polycarboxylic acids such as citric acid, adipic acid, succinic acid, glutaric acid, tartaric acid, saccharic acids, and mixtures thereof.

Moreover, polymeric polycarboxylates are suitable builders. These are, for example, the alkali metal salts of polyacrylic acid or of polymethacrylic acid, for example those having a relative molar mass from 600 to 750,000 g/mol. Suitable polymers are in particular polyacrylates, which preferably have a molar mass from 1,000 to 15,000 g/mol. Due to superior solubility, short-chain polyacrylates having molar masses from 1,000 to 10,000 g/mol, and particularly preferably from 1,000 to 5,000 g/mol, may in turn be preferred from this group.

Also suitable are copolymeric polycarboxylates, in particular those of acrylic acid with methacrylic acid, and of acrylic acid or methacrylic acid with maleic acid. To improve water solubility, the polymers can also contain allyl sulfonic acids, such as allyloxybenzene sulfonic acid and methallyl sulfonic acid, as a monomer.

However, soluble builders, such as citric acid/citrate, or acrylic polymers having a molar mass of 1,000 to 5,000 g/mol are preferred in the liquid to gel-like laundry detergents.

Preferred fabric softeners, and in particular liquid to gel-like fabric softeners, moreover include, for example, quaternary ammonium compounds, such as monoalk(en)yltrimethylammonium compounds, dialk(en)yldimethylammonium compounds, mono-, di- or triesters of fatty acids with alkanol amines as the softening active agent.

Suitable examples of quaternary ammonium compounds are shown in formulas (I) and (II), for example:

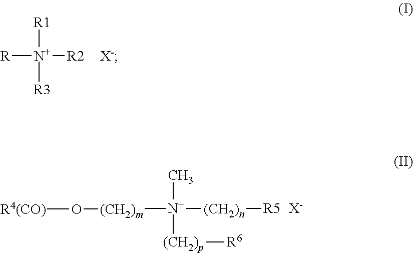

wherein in (I) R is an acyclic alkyl group having 12 to 24 carbon atoms, R1 is a saturated C₁-C₄ alkyl or hydroxyalkyl group, R2 and R3 are either equal to R or R1 or are an aromatic group; X⁻ is either a halide, methosulfate, methophosphate or phosphate ion, and mixtures of these. Examples of cationic compounds having the formula (I) are monotallow trimethyl ammonium chloride, monostearyl trimethyl ammonium chloride, didecyl dimethyl ammonium chloride, ditallow dimethyl ammonium chloride or dihexadecyl ammonium chloride.

Compounds having the formula (II) are known as esterquats. Esterquats are marked by outstanding biodegradability. In formula (II), R⁴ is an aliphatic alk(en)yl group having 12 to 22 carbon atoms comprising 0, 1, 2 or 3 double bonds and/or optionally comprising substituents; R⁵ is H, OH or O(CO)R⁷; R⁶, independently of R⁵, is H, OH or O(CO)R⁸, wherein R⁷ and R⁸ independently of one another are each an aliphatic alk(en)yl group having 12 to 22 carbon atoms comprising 0, 1, 2 or 3 double bonds; m, n and p, independently of one another, can each have the value 1, 2 or 3. X⁻ can be either a halide, methosulfate, methophosphate or phosphate ion, and mixtures of these anions. Compounds in which R⁵ represents the group O(CO)R⁷ are preferred. Compounds in which R⁵ represents the group O(CO)R⁷ and R⁴ and R⁷ are alk(en)yl groups having 16 to 18 carbon atoms are particularly preferred. In particular, compounds in which R⁶ is additionally OH are preferred.

Esterquats that are preferably used as the softening components are methyl-N-(2-hydroxyethyl)-N,N-di(tallow acyloxyethyl)ammonium methosulfate, bis-(palmitoyloxyethyl)hydroxyethyl methyl ammonium methosulfate, 1,2-[tallow acyloxy]-3-trimethylammonium propane chloride, N,N-dimethyl-N,N-di(tallow acyloxyethyl)ammonium methosulfate or methyl-N,N-bis(stearoyloxyethyl)-N-(2-hydroxyethyl)ammonium methosulfate.

If quaternized compounds having the formula (II) that comprise unsaturated alkyl chains are used, acyl groups are preferred, in which the corresponding fatty acids have an iodine value between 1 and 100, preferably between 5 and 80, more preferably between 10 and 60, and in particular between 15 and 45, and which have a cis/trans isomer ratio (in percent by weight) of greater than 30:70, preferably greater than 50:50, and in particular equal to or greater than 60:40. Commercially available examples include the methyl hydroxyalkyl dialkoyloxy alkyl ammonium methosulfates sold by Stepan under the trade name Stepantex®, or the products available from Cognis known under Dehyquart®, the products available from Degussa known under Rewoquart®, and the products available from Kao known under Tetranyl®.

Instead of the ester group O(CO)R, wherein R is a long-chain alk(en)yl group, softening compounds may be used that include the following groups: RO(CO), N(CO)R or RN(CO), wherein N(CO)R groups are preferred among these groups.

Moreover, cationic polymers are also suitable softening components. Some of these additionally exhibit skin care and/or textile care properties.

The softening component can be present in the fabric softener according to the invention in amounts of 0.1 to 80 wt. %, usually 1 to 40 wt. %, preferably 2 to 20 wt. %, and in particular 3 to 15 wt. %, in each case based on the total textile treatment composition.

The fabric softeners can comprise additional components, which include perfumes, perfume carriers, insect repellents, germicides, fungicides, antioxidants, preservatives, corrosion inhibitors, antistatic agents, repellents and impregnating agents, swelling and anti-slip agents, UV absorbers, and further fiber care components.

A further preferred embodiment of the invention relates to a textile treatment composition that is applied to a textile outside the washing machine and the dryer, and preferably is a post-treatment composition, for example an ironing spray. Such compositions preferably include at least one raw material made of compounds (1) and (2) in amounts of 3 to 50 wt. %, advantageously in amounts of at least 5 to 40 wt. %, and in particular 10 to 35 wt. %. These compositions are also preferably liquid to gel-like. The viscosity of the compositions is only limited in that the compositions still have to be sprayable. Such liquid to gel-like compositions can also be applied to a textile as a pre-treatment agent before the textile is subjected to a washing process, or it is used for in-between use, without a washing process having preceded or following before the textile is worn again.

Further ingredients of the preferred liquid to gel-like pre-/post-treatment compositions can be organic solvents. In a preferred embodiment of the invention, organic solvents (for description see hereafter) form the liquid basis for the pre-/post-treatment compositions, and in particular the ironing sprays. While the amount of the organic solvents can vary within a broad range, the organic solvents are preferably present in the pre-/post-treatment compositions in amounts of 20 to 99 wt. %, and in particular in amounts of 30 to 90 wt. %.

Particularly preferred are liquid to gel-like pre-/post-treatment compositions that, in addition to the ingredients having anti-wrinkle properties, also include active agents that to the improvement of the textile lubricant and shape retention properties and/or improve, prevent or mask bad odors. Such liquid to gel-like pre-/post-treatment compositions, and in particular ironing sprays, are in particular also suitable for being applied to textiles that are not present in a freshly washed state, but have already been worn again since being washed last, and in which not only is freshening sought, but also creases are to be reduced.

Suitable active agents that improve, prevent or mask bad odors include polyalkylene oxide polysiloxane surfactants, for example Silwet® L-77, Silwet® L-7280, Silwet® L-7608, DC Q2-5211 or Sylgard® 309, but also cyclodextrins, and in particular solubilized, not complexed cyclodextrin. Aldehydes may be used as a further optional odor control agent, in particular those that can be assigned to class I or class II, or mixtures of aldehydes of class I and class II. Further known odor control agents are flavanoids contained in typical essential oils, which can be obtained by way of dry neutralization from conifers or grasses. Metal salts, for example copper salts and/or zinc salts, can also help control odor. This list is not exhaustive. Cyclodextrins and/or flavanoids are particularly preferred. Active agents that improve, prevent or mask bad odors can also be used in laundry detergents and fabric softeners, however the use in ironing sprays is particularly preferred.

In addition to the active agents having anti-wrinkle, textile lubricant and shape retention properties, and active agents that improve, prevent or mask bad odors, the pre-/post-treatment compositions can contain other active agents, for example perfumes, perfume carriers, insect repellents, germicides, fungicides, antioxidants, preservatives, antistatic agents, repellents and impregnating agents, swelling and anti-slip agents, UV absorbers and further fiber care components. However, especially particularly preferred, pre-/post-treatment compositions, and in particular ironing sprays, shall be understood to mean those that comprise the other active agents in amounts of 0 to 20 wt. %, and in particular up to 10 wt. %.

The organic solvents used in laundry detergents and fabric softeners include monohydric and polyhydric alcohols, alkanol amines or glycol ethers. For example, the solvents are preferably selected from ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, methoxytriglycol, ethoxytriglycol, butoxytriglycol, 1-butoxyethoxy-2-propanol, 3-methyl-3-methoxy butanol, and mixtures of these solvents.

The organic solvents can vary within a broad range in the textile treatment compositions and be present, for example, in amounts of 10 to 99 wt. %, in liquid compositions on non-aqueous basis in amounts of 20 to 99 wt. %, and in particular of 30 to 90 wt. %.

Among the preferred liquid to gel-like textile treatment compositions, in turn, laundry detergents, fabric softeners and pre-/post-treatment compositions, such as ironing sprays, that constitute a liquid to gel-like composition on non-aqueous basis are in particular preferred. This shall be understood to mean that the compositions include less than 5 wt. % water (according to Karl Fischer), and preferably less than 2 wt. % water (according to Karl Fischer). This is particularly advantageous for pre-/post-treatment compositions such as ironing sprays.

In liquid to gel-like textile treatment compositions on non-aqueous basis, and in particular in liquid to gel-like pre-/post-treatment compositions on non-aqueous basis, the preferred organic solvents include isopropanol, diethyl ether, ethanol, acetone, ethyl acetate, dichloromethane, toluene, or mixtures of these, wherein isopropanol has been found to be particularly advantageous.

A further embodiment of the invention relates to a kit composed of a spray dispenser and a textile treatment composition according to the invention that is present in liquid to gel-like form. This embodiment is in particular advantageous for pre-/post-treatment compositions. However, it is also conceivable to use such a composition for pre-treating a textile before it is subjected to a washing process. Ironing sprays can be used as post-treatment compositions, but also as compositions for in-between use. The spray dispenser is composed of a spray dispenser housing, which can accommodate the textile treatment composition, and a spraying device, as it is widely known from the prior art. For example, the spraying device can he a spraying means of the pump lever type, the pump type without aerosol and inherent-pressure-charged, or with aerosol, and a not manually operated, electrical atomizer. Spraying devices of the first type are primarily suitable for applying the textile treatment composition onto smaller fabric surfaces and/or a small number of pieces of clothing, such as those that are present in households, while electrical atomizers are primarily suitable for applying the textile treatment composition uniformly onto large fabric surfaces or a larger quantity clothing articles, such as occur in laundry services, for example.

Spray dispensers comprising a manually operated pump lever spray head (trigger pump) are preferred for household use.

A further subject matter of the invention is a method for using a textile treatment composition according to the invention, wherein the textile treatment composition according to the invention is applied onto the dry or moistened, or still moist, textile by way of a spray dispenser, and in particular by way of a spray dispenser comprising a pump lever spray head (trigger pump).

Preferred are embodiments of the method in which a washing process with or without drying in a dryer preceded the textile post-treatment. In the case of a washing process with subsequent drying in a dryer, it is preferred for the textiles to be treated not to be fully dried, since complete drying could give rise to further creases and wrinkles. Fully dried textiles, as well as dry textiles that were not washed beforehand, can be moistened prior to being treated with the textile treatment composition.

Heat is needed to activate the textile treatment composition and to fix the unwrinkled state of the textile, wherein it has been found that the heat in a dryer is generally not sufficient. For this reason, the treated textile is exposed to temperatures of at least 130° C., and preferably of 130° C. to 165° C. This is preferably carried out by way of ironing. Surprisingly, it has been found that the surface of the textiles, after the textile has been treated several times with the textile treatment composition under the action of heat, is influenced such that, during further applications of the textile treatment composition, repeated loading of the textile surface with the textile treatment composition without heat activation, and thus without ironing, and nonetheless the desired effect of unwrinkling can be achieved. In this way, in particular a further application of the composition without a preceding washing process becomes very convenient because it suffices to simply spray the composition onto the wrinkled textile and allowing it to dry so as to achieve the desired effect. Within this meaning, a method is preferred in which a textile treated with a textile treatment composition according to the invention is subjected to temperatures of at least 130° C., and preferably of 130° C. to 165° C., preferably by way of ironing, and this step is optionally repeated, preferably up to four times, until the non-iron state is achieved. The non-iron state is generally achieved after a total of five applications and heat activation of the textile treatment composition, so that thereafter the textile treatment composition only has to be sprayed onto the wrinkled textile to be treated, but no heat treatment is required any more, to remove creases and wrinkles.

The non-iron state is preferably achieved when the textile treatment composition is used in amounts such that the concentration of the active raw material on the treated textile surface, either after one-time application or after several applications, is 1 to 20 wt. %, preferably 2 to 15 wt. %, and particularly preferably 3 to 10 wt. %, each based on the weight of the wrinkled, untreated textile surface in the dry state. Concentrations of active raw material higher than 10 wt. % may result in negative effects on the textiles, for example stickiness, while concentrations of less than 3 wt. % require multiple applications to achieve the non-iron state. However, both limits are dependent on the type of the textile and provide only reference values. These concentrations can be applied most easily to a textile by way of a post-treatment composition, such as an ironing spray, so that an ironing spray and the use thereof are in particular preferred with respect to achieving the non-iron state.

### EXAMPLES

### Example 1

### Synthesis of Substance A

1.52 g xylitol was dissolved in 50 ml dioxane at 90° C. After cooling to room temperature, 12.37 g (3-isocyanatopropyl)triethoxysilane (IPTES) and 112.2 mg 1,4-diazabicyclo[2.2.2]octane (DABCO) were added. The reaction took place while stirring at 90° C. over 22 hours. After the mixture was cooled to room temperature and the solvent was removed in a rotary evaporator, a cloudy, colorless gel was obtained.

### Example 2

### Synthesis of Substance B

0.96 g glycerol was dissolved in 30 ml dioxane and heated for a few minutes until a clear and colorless solution was obtained. After the mixture was cooled to room temperature, 7.45 g IPTES and 113.7 g DABCO were added. The reaction took place while stirring at 90° C. over 22 hours. After the mixture was cooled to room temperature and the solvent was removed in a rotary evaporator, a clear, colorless liquid was obtained.

### Example 3

### Synthesis of Substance C

2.0 g polyethylene glycol (not end-capped) having a molecular weight of 200 was dissolved in 30 ml tetrahydrofurane (THF). The addition of 10.42 g IPTES and 190 mg DABCO was carried out at room temperature. The reaction took place while stirring at 70° C. over 20 hours. After the mixture was cooled to room temperature and the solvent was removed in a rotary evaporator, a clear, colorless liquid was obtained.

### Example 4

### Application of the Textile Treatment Composition and Measurement of the Crease Recovery Angle

Textile treatment compositions A, B and C were produced by dissolving 8 wt. %, in each case based on the textile treatment composition, of substances A, B and C in isopropanol, respectively. The respective test fabric was moistened thoroughly with the textile treatment composition (weight ratio 1:1) and subsequently dried. Thereafter, the textile was ironed for 1 minute at a temperature of 130° C. to 165° C. For comparison, untreated test fabrics and test fabrics that were only treated with isopropanol were examined.

5 samples were taken in each case, the crease recovery angle was measured, and then the average value was calculated.

The measurement of the crease recovery angle was carried out in accordance with DIN 53890.

### Example 4A

Textile treatment composition A
Test fabric: 100% cotton (WFK 11A)
Loading time: 30 minutes
Examination of the warp threads
Recovery time: 5 and 30 minutes

TABLE 1
Results of the measurements for textile treatment composition 4A

| | Angle (average value) | | |
|---|---|---|---|
| | | | Test fabric |
| | | | comprising textile |
| | Untreated | Reference treated | treatment |
| Recovery time | reference | with isopropanol | composition 4A |
| 5 min | 55.2 | 49.2 | 72.0 |
| 30 minutes | 63.2 | 57.6 | 80.0 |

### Example 4B

Textile treatment composition B
Test fabric: 100% cotton (easy-care finish)
Loading time: 30 minutes
Examination of the warp threads
Recovery time: 5 and 30 minutes

TABLE 2
Results of the measurements for textile treatment composition 4B

| | Angle (average value) | |
|---|---|---|
| | Unfinished, | Test fabric comprising textile |
| Recovery time | untreated reference | treatment composition 4b |
| 5 min | 73.0 | 77.0 |
| 30 minutes | 83.4 | 88.4 |

### Example 4C

Textile treatment composition C
Test fabric: 100% cotton (WFK 11A)
Loading time: 30 minutes
Examination of the warp threads
Recovery time: 5 and 30 minutes

TABLE 3
Results of the measurements for textile treatment composition 4C

| | Angle (average value) | | |
|---|---|---|---|
| | | Reference | Test fabric |
| | | treated | comprising textile |
| | Untreated | with | treatment |
| Recovery time | reference | isopropanol | composition 4C |
| 5 min | 55.2 | 49.2 | 64.2 |
| 30 minutes | 63.2 | 57.6 | 72.0 |

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A raw material that constitutes the reaction product of two compounds (1) and (2) having the general formulas (1) and (2), wherein the first compound (1) has the general formula
R¹—(CH₂)ₐ—(CHR²)_{b}—(CR³₂)_{c}—(CHR⁴)_{d}—(CH₂)ₑ—R⁵ (1)
where
R¹, R², R³, R⁴ and R⁵, independently of one another, are each an OH, NH₂, NHR′ and/or SH reactive group, and R′ is a linear or branched alkyl chain having 1 to 10 carbon atoms, an alkaryl or aralkyl group having 6 to 10 carbon atoms, or an aryl group having 5 to 10 carbon atoms, and a, b, c, d, and e can each be 0 or an integer between 1 and 10, with the condition that the sum of a+b+c+d+e is an integer greater than 1;
and the second compound (2) has the general formula
Y-A-Si(OR1)ᵣ(R2)₃₋ᵣ (2)
where
Y is NCO, Br or Cl, COOH, COCl , an epoxy, aldehyde or acrylate group;
A is a linear or branched alkyl chain having 1 to 20 carbon atoms, an alkaryl or aralkyl group having 6 to 20 carbon atoms, or an aryl group having 5 to 20 carbon atoms;
OR1 is a hydrolyzable group;
R2 is a linear or branched alkyl group having 1 to 6 carbon atoms; and
r is a number from 1 to 3.

2. The raw material according to claim 1, characterized in that at least 2, functional groups of compound (1) are reacted with compound (2).

3. The raw material according to claim 1, characterized in that the compound having the formula (1) only comprises OH as the groups R¹ to R⁵, and/or the sum of a+b+c+d+e in the compound having the formula (1) is greater than 1, but no more than 20.

4. The raw material according to claim 1, characterized in that the compound having the general formula (2) is a functional silane derivative that is capable of reacting with respect to OH groups and NH₂ groups.

5. The method of producing a raw material according to claim 1, characterized in that a solution is prepared from the first compound having the general formula (1) in an organic solvent, optionally at an elevated temperature, and, after cooling, the compound having the general formula (2) is added at room temperature, at a molar ratio of compound (2) to compound (1) of 1:1 to (2+b+2c+d):1, optionally while adding a starter or a catalyst.

6. A textile treatment composition, comprising at least one raw material according to claim 1 in amounts of 1 to 50 wt. %.

7. The textile treatment composition according to claim 6, characterized in that the composition is a liquid to gel-like textile treatment composition, the at least one raw material being present in amounts of 1 to 20 wt. %.

8. The textile treatment composition according to claim 7, characterized in that the textile treatment composition is a liquid to gel-like composition on non-aqueous basis, comprising less than 5 wt. % water (according to Karl Fischer).

9. A kit, composed of a spray dispenser and a textile treatment composition according to claims 7.

10. A method for using a textile treatment composition according to claim 7, characterized in that the textile treatment composition is applied onto the dry or moistened, or still moist, textile by way of a spray dispenser.
